(19) United States
(12) Patent Application Publication
(10) Pub. No.: US 2014/0379508 A1
(43) Pub. Date: Dec. 25, 2014

(54) MERCHANT BUSINESS HOURS DATABASE VIA TRANSACTION DATA APPARATUS AND METHOD

(71) Applicant: MasterCard International Incorporated, Purchase, NY (US)

(72) Inventors: Ramamohan Sangasani, White Plains, NY (US); Tong Zhang, Greenwich, CT (US); Bruce William MacNair, Stanford, CT (US)

(21) Appl. No.: 14/312,330

(22) Filed: Jun. 23, 2014

Related U.S. Application Data
(60) Provisional application No. 61/838,137, filed on Jun. 21, 2013.

(51) Int. Cl. G06Q 30/06

(52) U.S. Cl. CPC G06Q 30/0601
USPC 705/26.1

(57) ABSTRACT

A system, method, and computer-readable storage medium configured to determine merchant business hours using financial transactions.

### RELATED APPLICATIONS

This application claims priority to provisional U.S. Patent Application Ser. No. 61/838,137, entitled “Merchant Business Hours Database via Transaction Data Apparatus and Method,” filed on Jun. 21, 2013.

### BACKGROUND

1. Field of the Disclosure

Aspects of the disclosure relate in general to financial services. Aspects include an apparatus, system, method and computer-readable storage medium to determine merchant business hours using financial transactions.

2. Description of the Related Art

For centuries, financial transactions have used currency, such as banknotes and coins. For example, traditionally, whenever travelers leave home, they carried to pay for expenses, such as shopping, transportation, lodging, and food.

In modern times, however, payment cards are rapidly replacing cash to facilitate payments. Payment cards provide the clients of a financial institution (“cardholders”) with the ability to pay for goods and services without the inconvenience of using cash. A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards eliminate the need for carrying large amounts of currency. Moreover, in international travel situations, payment cards obviate the hassle of changing currency.

There are over ten million merchant locations in the United States. Throughout the entire world, there are an even greater number of merchant locations. While some merchants publish their business hours on a web-site, or make this information available via the telephone, many merchants do not make their business hour information available remotely. Moreover, due to the sheer number of merchants, it is a costly and difficult task to collect business hour information manually.

### SUMMARY

Embodiments include a system, device, method and computer-readable medium to determine merchant business hours using financial transactions.

In a method embodiment, the method determines business hours of a merchant. A processor extracts payment card transaction authorization information for the merchant. The payment card transaction authorization information includes a time and a date of multiple payment card authorizations. The processor groups each of the multiple payment card authorizations into days of a week. The processor determines an opening time and a closing time of at least one of the days of the week based at least in part on a first and a last payment card transaction authorization. A non-transitory computer-readable storage medium stores the opening and the closing time.

A business hours calculation server embodiment comprises a processor and a computer-readable storage medium. The processor is configured to extract payment card transaction authorization information for the merchant. The payment card transaction authorization information includes a time and a date of multiple payment card authorizations. The processor is further configured to group each of the multiple payment card authorizations into days of a week. The processor is configured to determine an opening time and a closing time of at least one of the days of the week based at least in part on a first and a last payment card transaction authorization. The non-transitory computer-readable storage medium stores the opening and the closing time.

A non-transitory computer-readable storage medium embodiment is encoded with data and instructions. When the instructions are executed by a computing device, the instructions cause the computing device to determine business hours of a merchant. A processor extracts payment card transaction authorization information for the merchant. The payment card transaction authorization information includes a time and a date of multiple payment card authorizations. The processor groups each of the multiple payment card authorizations into days of a week. The processor determines an opening time and a closing time of at least one of the days of the week based at least in part on a first and a last payment card transaction authorization. The non-transitory computer-readable storage medium stores the opening and the closing time.

### BRIEF DESCRIPTION OF THE DRAWINGS

FIG. 1 illustrates an embodiment of a system to determine merchant business hours using financial transactions with a payment network.

FIG. 2 is a block diagram of a business hours calculation server configured to determine merchant business hours using financial transactions.

FIG. 3 illustrates a method of determining merchant business hours using financial transactions.

### DETAILED DESCRIPTION

One aspect of the disclosure includes the understanding that many merchants accept payment cards for transactions.

Another aspect of the disclosure is the realization that payment card financial transactions may be used to determine a merchant's business hours.

Embodiments of the present disclosure include a system, method, and computer-readable storage medium configured to determine a merchant's business hours using financial transaction data.

These and other aspects may be apparent in hindsight to one of ordinary skill in the art.

For the purposes of this disclosure, a payment card includes a stored-value card (such as a transit card or gift card), credit card, debit card, automatic teller machine (ATM) card, charge card, electronic wallet, Radio Frequency Identifier (RFID) device, cloud-based payment device, or any other electronic payment device known in the art.

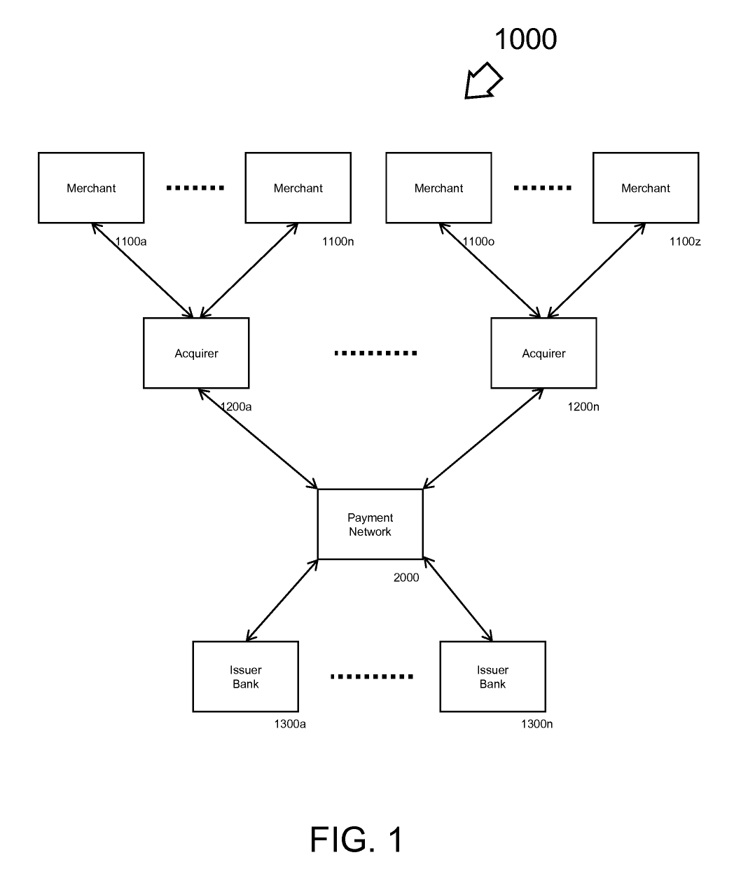

Payment cards are affiliated with payment networks, which are operational networks that enable monetary exchange between parties. An example payment network includes MasterCard International Incorporated of Purchase, N.Y. FIG. 1 illustrates an embodiment of a system 1000 configured to determine merchant business hours using financial transactions with a payment network 1400, constructed and operative in accordance with an embodiment of the present disclosure. As shown in FIG. 1, a payment network 1400 may be coupled to numerous merchants 1100a-z via acquirer financial institutions 1200a-n. During a typical financial transaction, a customer pays for a product or service at a merchant 1100. The merchant 1100 either directly contacts the payment network 1400, or (as shown in FIG. 1) contacts the payment network 1400 via its acquirer financial institution 12000 for approval or decline of the transaction. Most of the time the payment network 1400 contacts the issuer 1300 of the payment card to determine the credit worthiness of the cardholder in determining the approval or decline. There may be more than one issuer 1300a-n in such a system 1000. A record of the authorization of the transaction is recorded at the payment network 1400. The recorded authorization information includes the merchant, the payment card information, and the time/date of the transaction.

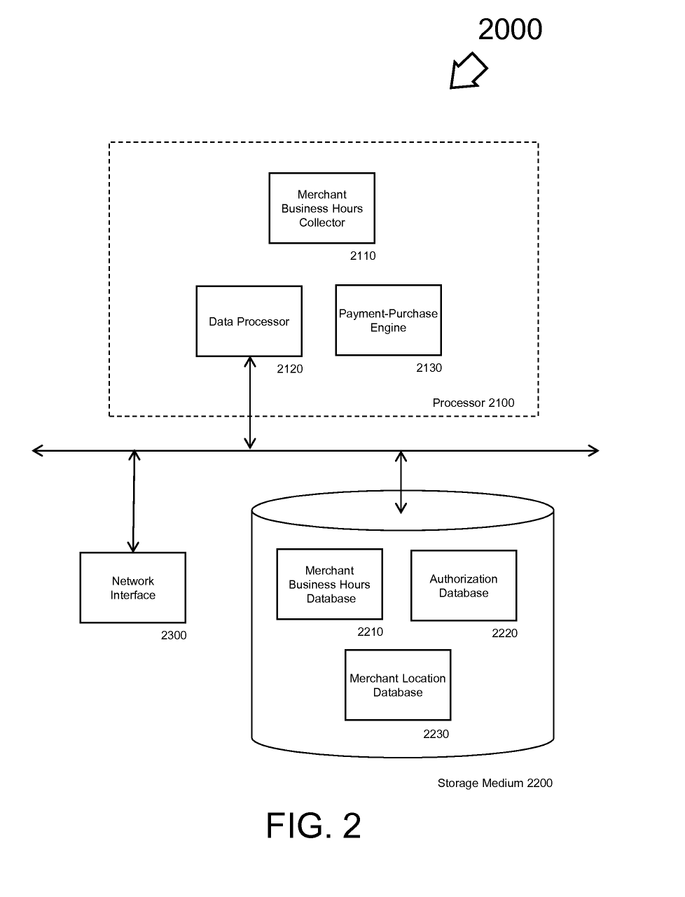

FIG. 2 is a block diagram of a business hours calculation server 2000 configured to determine merchant business hours using financial transactions, constructed and operative in accordance with an embodiment of the present disclosure. In some embodiments, the computing device may be located at the payment network 1400 or at an issuer 1300. For the sake of illustration only, an embodiment will be described in which the business hours calculation server resides at the payment network 1400. The business hours calculation server 2000 comprises a processor, a network interface, and a non-transitory computer-readable storage medium.

Business hours calculation server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may communicate with and temporarily store information in Random Access Memory (RAM) (not shown).

As shown in FIG. 2, processor 2100 is functionally comprised of a merchant business hours collector 2110, a payment-purchase engine 2130, and a data processor 2120.

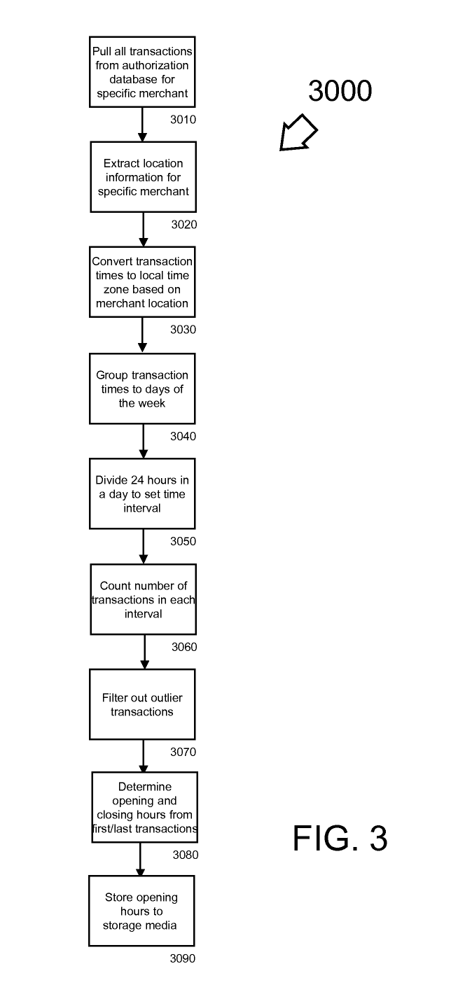

Merchant business hours collector 2110 is the structure that enables the business hours calculation server 2000 to analyze financial transactions and determine the business hours of a merchant 1100 based on the timing of the financial transactions. The functionality of merchant business hours collector 2110 is described in greater detail in FIG. 3.

Payment-purchase engine 3130 may be any structure that facilitates payment from customer accounts at an issuer 2300 to a merchant 1100. The customer accounts may include payment card accounts, checking accounts, savings accounts and the like.

Data processor 2120 enables processor 2100 to interface with storage medium 2200, network interface 2300 or any other component not on the processor 2100. The data processor 2120 enables processor 2100 to locate data on, read data from, and write data to these components.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows business hours calculation server 2000 to communicate with vendors, cardholders, and/or issuer financial institutions.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a merchant business hours database 2210, authorization database 2220, and merchant location database 2230.

Merchant business hours database 2210 is the data structure that stores merchant business hours, as determined by merchant business hours collector 2110.

Authorization database 2220 may be a linked-list, table, or any data structure known in the art that contains a record of payment card financial transactions. Table 1 below illustrates an example authorization table.

TABLE 1
Example excerpt of an Authorization Database
organized as a table. [INVENTORS: IS THIS CORRECT? IS
THIS THE AUTHORIZATION DATABASE, OR IS THIS
THE MERCHANT HOURS DATABASE?]

| Merchant Name | Days | Time Interval | Txn Count |
|---|---|---|---|
| A | Monday | 0:00 | 0 |
| A | Monday | 0:30 | 0 |
| A | Monday | 1:00 | 0 |
| A | Monday | 1:30 | 0 |
| A | Monday | 2:00 | 0 |
| A | Monday | 2:30 | 0 |
| A | Monday | 3:00 | 0 |
| A | Monday | 3:30 | 0 |
| A | Monday | 4:00 | 0 |
| A | Monday | 4:30 | 0 |
| A | Monday | 5:00 | 0 |
| A | Monday | 5:30 | 0 |
| A | Monday | 6:00 | 0 |
| A | Monday | 6:30 | 0 |
| A | Monday | 7:00 | 0 |
| A | Monday | 7:30 | 0 |
| A | Monday | 8:00 | 0 |
| A | Monday | 8:30 | 0 |
| A | Monday | 9:00 | 3 |
| A | Monday | 9:30 | 7 |
| A | Monday | 10:00 | 3 |
| A | Monday | 10:30 | 10 |
| A | Monday | 11:00 | 5 |
| A | Monday | 11:30 | 14 |
| A | Monday | 12:00 | 12 |
| A | Monday | 12:30 | 13 |
| A | Monday | 13:00 | 4 |
| A | Monday | 13:30 | 7 |
| A | Monday | 14:00 | 4 |
| A | Monday | 14:30 | 3 |
| A | Monday | 15:00 | 4 |
| A | Monday | 15:30 | 4 |
| A | Monday | 16:00 | 5 |
| A | Monday | 16:30 | 4 |
| A | Monday | 17:00 | 7 |
| A | Monday | 17:30 | 4 |
| A | Monday | 18:00 | 3 |
| A | Monday | 18:30 | 4 |
| A | Monday | 19:00 | 8 |
| A | Monday | 19:30 | 9 |
| A | Monday | 20:00 | 13 |
| A | Monday | 20:30 | 15 |
| A | Monday | 21:00 | 18 |
| A | Monday | 21:30 | 0 |
| A | Monday | 22:00 | 0 |
| A | Monday | 22:30 | 0 |
| A | Monday | 23:00 | 0 |
| A | Monday | 23:30 | 0 |

Merchant location database 2230 may be any data structure in the art that contains geographic information for a merchant 1100. The geographic information for merchant 1100 may include the time zone in which the merchant is located.

These structures may be implemented as hardware, firmware, or software encoded on a non-transitory computer readable medium, such as storage media. Further details of these components are described with their relation to method embodiments below.

It is understood by those familiar with the art that one or more of these databases 2210-2230 may be combined in a myriad of combinations. The function of these structures may best be understood with respect to the data flow diagram of FIG. 3, as described below.

These structures may be implemented as hardware, firmware, or software encoded on a non-transitory computer readable medium, such as storage media. Further details of these components are described with their relation to method embodiments below.

FIG. 3 illustrates a method 3000 of determining merchant business hours using financial transactions, constructed and operative in accordance with an embodiment of the present disclosure.

Initially, for a particular merchant location, merchant business hours collector 2110 extracts all the transaction date and time information (for a given time period) from the authorization database 2220, block 3010. In some embodiments, the time period could be a year or less. Because of the 24-hour nature of most on-line and travel businesses (e.g., hotel and airlines), these merchants 1100 may be excluded.

The location information is extracted from the merchant location database 2230 for the selected merchant 1100, block 3020. The location information allows the merchant business hours collector 2110 to covert time information to the local time zone based on the merchant location, block 3030.

The transactions are grouped into the seven days of the week (Sunday through Saturday), block 3040.

Depending upon granularity of the time-interval desired, for each day of the week the day is divided into intervals, block 3050. For example, for half-hour intervals, the 24 hours is divided into 48 time intervals.

For each time interval, the number of transaction falling in that interval is determined, as shown in Table 1, block 3060.

Next, outlier transactions are filtered out, block 3070. Outlier transactions are “noise” and other transactions that occur outside the normal business hours. For example, some noise transactions include late night transactions from some merchants. Other outlier transactions occur because of shopping holidays, for example, “Black Friday.” Outlier transactions may be filtered for local holidays, for example. Additionally, some merchants use batch authorization which would occur outside the normal business hours; these authorizations can be detected as unusually high peaks in a time interval. The batch authorizations are filtered out. In some embodiments, to eliminate random noise transactions, a minimum cutoff ratio is set up, where the transaction counts have to exceed a minimum threshold to be considered valid.

Based on the pattern of the transaction count time series, such as gaps and cliffs, a pattern is detected, block 3080.

The intervals that contain the first transaction in a day may be correlated to the opening time and the last transaction correlated the closing time. Note that for some types of merchants, such restaurants that close after lunch and reopen at dinner, the merchants may have more than one opening or closing time. This process is able to detect such openings and closing times.

After detecting the opening and closing times, the information is stored on to storage media, block 3090.

To enable the embodiments described, it is understood that hardware, software, and firmware encoded on to non-transitory computer readable media are utilized.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and features disclosed herein.

What is claimed is:

1. A method of determining business hours of a merchant, the method comprising:
extracting, with a processor, payment card transaction authorization information for the merchant, the payment card transaction authorization information including a time and a date of multiple payment card authorizations;
grouping, with the processor, each of the multiple payment card authorizations into days of a week;
determining, with the processor, an opening time and a closing time of at least one of the days of the week based at least in part on a first and a last payment card transaction authorization;
storing the opening and the closing time on a non-transitory computer-readable storage medium.

2. The method of claim 1 further comprising:
converting the time of each of the multiple payment card transaction authorizations into a local time based on a location of the merchant with the processor.

3. The method of claim 2 further comprising:
dividing each of the days of the week into intervals with the processor.

4. The method of claim 3 further comprising:
sorting each of the multiple payment card transaction authorizations into the intervals with the processor.

5. The method of claim 4 further comprising:
removing, with the processor, outlier transactions from the intervals, resulting in filtered intervals.

6. The method of claim 5 wherein the determining the opening time and the closing time of the at least one of the days of the week is based at least in part on the filtered intervals.

7. The method of claim 6 further comprising:
determining the opening time and the closing time of each of the days of the week based at least in part on the filtered intervals.

8. A business hours calculation server comprising:
a processor configured to extract payment card transaction authorization information for a merchant, the payment card transaction authorization information including a time and a date of multiple payment card authorizations, configured to group each of the multiple payment card authorizations into days of a week, configured to determine an opening time and a closing time of at least one of the days of the week based at least in part on a first and a last payment card transaction authorization;
a non-transitory computer-readable storage medium configured to store the opening and the closing time.

9. The business hours calculation server of claim 8 wherein the processor is further configured to convert the time of each of the multiple payment card transaction authorizations into a local time based on a location of the merchant.

10. The business hours calculation server of claim 9 wherein the processor is further configured to divide each of the days of the week into intervals.

11. The business hours calculation server of claim 10 wherein the processor is further configured to sort each of the multiple payment card transaction authorizations into the intervals.

12. The business hours calculation server of claim 11 wherein the processor is further configured to remove outlier transactions from the intervals, resulting in filtered intervals.

13. The business hours calculation server of claim 12 wherein the determining the opening time and the closing time of the at least one of the days of the week is based at least in part on the filtered intervals.

14. The business hours calculation server of claim 13 wherein the processor is further configured to determine the opening time and the closing time of each of the days of the week based at least in part on the filtered intervals.

15. A non-transitory computer-readable storage medium encoded with data and instructions that when the instructions are executed by a computing device, causes the computing device to:
extract, with a processor, payment card transaction authorization information for a merchant, the payment card transaction authorization information including a time and a date of multiple payment card authorizations;
group, with the processor, each of the multiple payment card authorizations into days of a week;
determine, with the processor, an opening time and a closing time of at least one of the days of the week based at least in part on a first and a last payment card transaction authorization;
store the opening and the closing time on the non-transitory computer-readable storage medium.

16. The non-transitory computer-readable storage medium of claim 15 further causing the computing device to:
convert the time of each of the multiple payment card transaction authorizations into a local time based on a location of the merchant with the processor.

17. The non-transitory computer-readable storage medium of claim 16 further causing the computing device to:
divide each of the days of the week into intervals with the processor.

18. The non-transitory computer-readable storage medium of claim 17 further causing the computing device to:
sort each of the multiple payment card transaction authorizations into the intervals with the processor.

19. The non-transitory computer-readable storage medium of claim 18 further causing the computing device to:
remove, with the processor, outlier transactions from the intervals, resulting in filtered intervals.

20. The non-transitory computer-readable storage medium of claim 19 wherein the determining the opening time and the closing time of the at least one of the days of the week is based at least in part on the filtered intervals.
